(19) United States
(12) Patent Application Publication
(10) Pub. No.: US 2024/0217883 A1
(43) Pub. Date: Jul. 4, 2024

(54) METHOD FOR PRODUCING HIGH-PURITY, DENSE SINTERED SIC MATERIAL

(71) Applicant: SAINT-GOBAIN CENTRE DE RECHERCHES ET D'ETUDES EUROPEEN, COURBEVOIE (FR)

(72) Inventors: Giovanni MASSASSO, SALON-DE-PROVENCE (FR); Costana BOUSQUET, CAVAILLON (FR)

(21) Appl. No.: 18/557,141

(22) PCT Filed: Apr. 29, 2022
(86) PCT No.: PCT/FR2022/050832

§ 371 Date: Oct. 25, 2023

(30) Foreign Application Priority Data
Apr. 30, 2021 (FR) 2104578

(51) Int. Cl. C04B 35/575; C04B 35/63

(52) U.S. Cl. CPC C04B 35/575; C04B 35/6303; C04B 2235/3821; C04B 2235/3834; C04B 2235/422; C04B 2235/5436; C04B 2235/5445; C04B 2235/656; C04B 2235/6584; C04B 2235/666; C04B 2235/723; C04B 2235/725; C04B 2235/786

(57) ABSTRACT

A polycrystalline silicon carbide sintered material includes silicon carbide grains having a median equivalent diameter of between 1 and 10 microns, the material having a total porosity of less than 2% by volume of the material, and a silicon carbide mass content of at least 99%, except for the free carbon, wherein in the material the mass ratio of the content of SiC having a beta-type crystallographic form to the content of SiC having an alpha-type crystallographic form is less than 2.

The invention relates to a sintered material based on silicon carbide (SiC) of high purity and, more particularly, to a method for manufacturing such a material.

Silicon carbide materials have been known for a long time for their high degrees of hardness, chemical inertia, thermal and mechanical resistance, and thermal conductivity. This makes them candidates of choice for applications such as cutting or machining tools; turbine components or pump elements subjected to high abrasion; pipe valves carrying corrosive products; supports and membranes intended for filtration or pollution or liquid; supports and membranes for filtration or removal of gas or liquid; heat exchangers and solar absorbers, coatings or materials for thermochemical treatment of reactors, in particular for etching, or substrates intended for the electronics industry; temperature sensors or heating resistors; high temperature or pressure sensors or sensors for very aggressive environments; igniters or magnetic susceptors that are more resistant to oxidation than those made of graphite; and even certain special applications such as mirrors or other optical devices.

However, by sintering a material of a polycrystalline silicon carbide of very high density (that is with a relative density greater than 99%) and of high purity (that is, a mass content of SiC greater than 98.5%, or even SiC greater than 99.0%) remains a technical challenge.

Methods for obtaining a dense ceramic body of silicon carbide have long been known without resorting to sintering additives that form a liquid phase detrimental to mechanical behavior at very high temperature (>1500° C.).

U.S. Pat. No. 4,004,934 for example discloses a method for pressureless solid-phase sintering at a temperature between 1900 and 2100° C. of a preform obtained by cold-pressing a mixture comprising a very pure powder of SiC in beta crystalline form with an addition of carbon in the form of a phenolic resin representing in mass between 0.1 to 1.0% of this element relative to the SiC and a compound of boron representing by mass between 0.3 to 3.0% of this element relative to the SiC.

More recently US 2006/0019816 proposed a method for manufacturing starting from a slip comprising silicon carbide particles, a carbon source in the form of a water-soluble resin representing, by mass, 2 to 10% of that of SiC and a boron source, for example boron carbide, representing, by mass, 0.5 to 2% of that of SiC.

More recently WO2019132667A1 proposed a method for producing a homogeneous mixture by co-grinding in an aqueous medium of 94% alpha SiC particles, 1% boron carbide particles and 5% a carbon source making it possible to achieve, after spraying, pouring, and sintering without load in argon and at more than 2100° C., a sintered body having a relative density of 96 to 98%.

However, these solutions do not make it possible to obtain a final material whose content is greater than 98.5% or even greater than 99% SiC, given the boron content and the inevitable impurities linked to the starting powders.

The publication “Densification of additive-free polycristalline β-SiC by spark-plasma sintering” published in Ceramic International 38(2012) 45-53 by Ana Lara et al. shows that it is possible to obtain a material of very high purity and a relative density of 98% at 2100° C. by SPS sintering without any additive, starting from an ultrapure beta-type SiC powder, but the size of which is nanometric, the particles or crystallites having a median size of 10 nanometers. The use of such a powder poses numerous handling problems and makes such a method difficult to scale up industrially.

There is therefore a need for an scalable manufacturing process of a sintered SiC material having a relative density greater than 98%, preferably greater than 98.5%, or even greater than 99%, and a SiC mass content greater than 99%, except for the free carbon.

### SUMMARY OF THE INVENTION

The work of the applicant company, as described below, has demonstrated a combination in terms of composition, mixture formulation and sintering technique, making it possible to achieve such an objective.

The invention relates more particularly to a first aspect of a method for manufacturing a polycrystalline sintered silicon carbide material comprising the following steps:
a) Preparing a mineral feedstock comprising, and preferably essentially consisting of, by mass:
   at least 95%, preferably at least 97%, silicon carbide particles, in the form of a powder, the median size of which is between 0.1 and 5 micrometers and with a SiC mass content greater than 95%, preferably greater than 97%, wherein powder the beta crystallographic form represents more than 90%, preferably more than 95%, of the total mass of the silicon carbide, and
   at least one solid-phase sintering additive, preferably in the form of a powder, comprising an element selected from aluminum, boron, iron, titanium, chromium, magnesium, hafnium or zirconium, preferably chosen from B, Ti, Hf or Zr, preferably chosen from B or Zr, even more preferably B, preferably of purity greater than 98% by mass, in an amount such that the contribution of said element represents between 0.1 and 0.8%, preferably between 0.2 and 0.7%, of the total mass of said particles of silicon carbide,
   between 0.5 and 3% of a carbon source whose elemental carbon content (C) is greater than 99% by mass, preferably in the form of an uncrystallized or amorphous graphite or carbon powder, the median diameter of which is less than 1 micrometer,
b) Shaping the feedstock into the form of a preform, preferably by pouring,
c) Solid phase sintering of said preform under a pressure greater than 60 MPa, preferably greater than 75 MPa, or even greater than 80 MPa, and at a temperature greater than 1800° C. and less than 2100° C. in a nitrogen atmosphere, preferably under dinitrogen.

According to other optional and advantageous additional features of said method:
The mass content of free or residual carbon in the powder of silicon carbide particles is less than 3%, preferably less than 2%, preferably less than 1.5%. Preferably, the free carbon is present in the silicon carbide of the powder only in the form of unavoidable impurities.
The mass content of free or residual silica in the powder of silicon carbide particles is less than 2%, preferably less than 1.5%, preferably less than 1%.
The mass content of free or residual silicon in the powder of silicon carbide particles is less than 0.5%, preferably less than 0.1%.
Preferably, the free silica is present only in the form of unavoidable impurities.
The mass content of the element aluminum (Al), in metallic and non-metallic form, in the powder of silicon carbide particles is less than 0.2%. Preferably, aluminum is present only in the form of unavoidable impurities.
The mass content of the powder of silicon carbide particles in terms of the sum of the elements sodium (Na)+Calcium (Ca)+Potassium (K)+magnesium (Mg) is less than 0.2%. Preferably, said elements are present only in the form of unavoidable impurities.
The mass content of the powder of silicon carbide particles in the sum of the elemental contents of aluminum (Al), alkali, alkaline earth, and rare earths, is less than 0.5%. The rare earth elements are Sc, Y, La, Ce, Pr, Nd, Pm, Sm, Eu, Gd, Tb, Dy, Ho, Er, Tm, Yb and Lu. Preferably, all these elements are present only in the form of unavoidable impurities.
The element comprised in the sintering additive is preferably boron. Preferably, the sintering additive is a boron carbide powder.
The element comprised in the sintering additive is according to a particular embodiment, zirconium. Preferably, the sintering additive is a zirconium carbide powder. According to one possible mode, the sintering additive is a powder of zirconium boride.
the median diameter of the sintering powder is less than 2 micrometers, preferably less than 1 micrometer.
The specific surface area of the silicon carbide powder in beta crystalline form is greater than 5 cm²/g and/or less than 30 cm²/g.
The silicon carbide powder in beta crystalline form is bimodal and has two peaks, even more preferably a first peak, the high point of which is between 0.2 and 0.4 microns and a second peak, the high point of which is between 2 and 4 microns.

Any shaping technique known to the person skilled in the art can be applied as a function of the dimensions of the part to be made as soon as all the precautions are taken to avoid contamination of the preform. Thus, the casting in a plaster mold can be adapted by using graphite media between the mold and the preform or oils avoiding excessive contact and abrasion of the mold by mixing and finally contamination of the preform. These controlled precautions for use by the person skilled in the art are also applicable to other steps of the method. Thus, during sintering, the mold or the matrix used containing the preform will preferably be made of graphite.

Hot pressing, hot isostatic pressing, or SPS (Spark Plasma Sintering) techniques are particularly suitable. Preferably, pressure-assisted sintering is carried out by SPS, a sintering process implementing induction heating by direct current flow into a graphite matrix wherein the preform is placed. The average temperature rise rate is preferably greater than 10 and less than 100° C./minute. The plateau time at the maximum temperature is preferably greater than 10 minutes. This time may be longer depending on the format of the preform and the load of the furnace.

The nitrogen used for the sintering atmosphere in step c) is of purity greater than 99.99%, or even greater than 99.999% by volume.

According to one possible embodiment, an optional addition of carbon can be carried out according to a mass ratio of between 0.15 and 0.25 times the mass content of free silica in said silicon carbide powder in the feedstock in order to form silicon carbide by reaction and thus to eliminate this free silica.

Preferably, the addition of carbon represents less than 3% of elemental carbon (C) by mass relative to that of silicon carbide of the mineral feedstock.

According to another possible embodiment, the silicon (preferably in the form of a metal powder, whose elemental content of silicon (Si) is greater than 99% by mass and whose median diameter is preferably less than 1 micrometer) can optionally be added to the feedstock in a mass ratio of between 1.5 and 2.5 times the mass content of free carbon in said silicon carbide powder in the starting beta crystalline form in order to form silicon carbide by reaction and thus remove this free carbon.

Preferably, the addition of silicon represents less than 2% by mass of elemental silicon (Si) by mass relative to that of silicon carbide of the mineral feedstock.

The invention also relates to a polycrystalline material consisting of sintered grains of silicon carbide capable of being manufactured by the method described above, whose total porosity represents less than 2%, preferably less than 1.4%, preferably less than 1.2%, more preferably less than 1%, in percentage by volume of said material and whose mass content of silicon carbide (SiC) is at least 99%, apart from the free carbon, the mass ratio of the content of SiC in the beta crystallographic form (β) to the SiC content in alpha crystallographic form (α) of said material being less than 2. Said polycrystalline material consists of grains of silicon carbide having a median equivalent diameter of between 1 and 10 micrometers.

According to other optional and advantageous additional features of said material:
the mass content of oxygen (O) of said material is less than 0.5%, preferably less than 0.4%, or even less than 0.3%. Preferably, the oxygen is present in the material only in the form of unavoidable impurities.
the total elemental content of Sodium (Na)+Potassium (K)+Calcium (Ca) is cumulatively less than 0.5% of the mass of said material. Preferably, the sodium, potassium, and calcium are present in the material only in the form of unavoidable impurities.
the sum of the elemental mass contents of aluminum (Al), alkali, alkaline earth metal, rare earth metal, comprising at least one element selected from Sc, Y, La, Ce, Pr, Nd, Pm, Sm, Eu, Gd, Tb, Dy, Ho, Er, Tm, Yb and Lu, is less than 0.5% of the mass of said material. Preferably, said elements are present in the material only in the form of unavoidable impurities.
the elemental mass content of boron (B) in said material is greater than 0.1% and/or less than 0.7%, preferably less than 0.6% by mass of said material. According to one possible mode, the mass content of boron (B) is less than 0.5% by mass of said material.
the elemental mass content of zirconium (Zr) in said material is greater than 0.1% and/or less than 0.7%, preferably less than 0.6% by mass of said material. According to one possible mode, the mass content of zirconium is less than 0.5% by mass of said material.
the elemental content of molybdenum (Mo) is less than 0.2% of the mass of said material, preferably less than 0.1% of the mass of said material.
the elemental content of titanium (Ti) is less than 0.5% of the mass of said material, preferably 0.2%, preferably less than 0.1% of the mass of said material.
the elemental mass content of nitrogen (N) in said material is between 0.05 and 0.5%, preferably greater than or equal to 0.1 and/or less than 0.3%.
the elemental mass content of iron (Fe) represents less than 0.5% of the mass of said material. Preferably, the iron is present in the material only in the form of unavoidable impurities.
silicon in another form than silicon carbide SiC represents less than 1% of the mass of said material. Preferably, the silicon in another form than silicon carbide SiC is present in the material only in the form of unavoidable impurities.
The carbon in another form than silicon carbide SiC represents less than 2% of the mass of said material.
The mass content of free or residual carbon in said material is less than 1.5%, preferably less than 1.0%.
Preferably, the carbon in another form than silicon carbide SiC is present in the material only in the form of unavoidable impurities.
The mass content of free or residual silica in said material is less than 1.5%, preferably less than 1.0%, preferably less than 0.5%.
The mass content of free or residual silicon in said material is less than 0.5%, preferably less than 0.1%.
SiC represents more than 97%, preferably more than 98% of the mass of said material, including free carbon.
the mass ratio of the content of SiC in beta crystallographic form (β) to the SiC content in alpha crystallographic form (α) SiC of said material is less than 1.5, preferably less than 1, or even less than 0.3 or even less than 0.2 or even less than 0.1.
the mass ratio of the content of SiC in beta crystallographic form (β) to the SiC content in alpha crystallographic form (α) SiC of said material is greater than 0.01, more preferably greater than 0.02.
Said material comprises more than 1% by mass of SiC in beta crystallographic form, preferably more than 3% by mass of SiC in beta crystallographic form, relative to the total mass of the crystallized phases in the material.
SiC in beta crystallographic form (β) represents preferably less than 50% of the mass of the crystalline phases of said material.
silicon carbide grains represent at least 98%, preferably 99% by mass of said material, the remainder consisting of a residual intergranular phase comprising, preferably consisting essentially of elements Si and C.
In the material according to the invention, nitrogen can be present in the grains by insertion into the crystal lattice of the SiC.
by volume of said material, apart from its porosity, more than 90%, preferably more than 95% of the constituent grains of said material have an equivalent diameter of between 1 and 10 microns, preferably between 1 and 8 microns.
by volume more than 90%, preferably more than 95%, even more preferably all the silicon carbide grains in alpha crystalline form have an equivalent diameter of less than 10 micrometers.

According to one possible embodiment, the invention relates to a polycrystalline silicon carbide sintered material consisting of silicon carbide grains having a median equivalent diameter of between 1 and 10 microns, said material having a total porosity of less than 2% by volume of said material, and a silicon carbide (SiC) mass content of at least 99%, except for the free carbon, wherein in said material the mass ratio of the content of SiC having a beta-type crystallographic form (β) to the content of SiC having an alpha-type crystallographic form (α) is less than 2, and having the following elemental composition, by weight:
less than 0.5% silicon in another form than SiC,
less than 2.0% carbon in another form than SiC, preferably less than 1.5% carbon in another form than SiC, in particular between 0.5 and 1.5% carbon in another form than SiC and
between 0.1 and 0.7%, in total, of at least one element selected from, Al, B, Fe, Ti, Cr, Mg, Hf or Zr, preferably said element being chosen from B, Zr, Hf or Ti, said element even more preferably being B, Zr or Ti, still more preferably the element being B,
less than 0.5% oxygen (O) and
less than 0.5% in total of the elements Sc, Y, La, Ce, Pr, Nd, Pm, Sm, Eu, Gd, Tb, Dy, Ho, Er, Tm, Yb and Lu, and
less than 0.5% alkali elements, and
less than 0.5% alkaline earth, and
between 0.05 and 1% nitrogen (N),
the other elements forming the complement to 100%,
   and wherein the mass ratio of the SiC content in beta crystallographic form (β) to the SiC content in alpha crystallographic form (α) of said material being less than 2.

The invention also relates to a device comprising at least one part consisting of said material as previously described, said device being chosen from: a turbine, a pump, a valve or a fluid line system, a heat exchanger; a solar absorber or a device for recovering heat or reflecting light, a furnace refractory coating, a cooking surface, a crucible for melting metal, an abrasion protection part, a cutting tool, a brake pad or disc, a radome, a coating or support for thermochemical treatment, for example etching, or a substrate for active layer deposition for the optics and/or electronics industry; a heating element or resistor; a temperature or pressure sensor; an igniter; a magnetic susceptor.

### Definitions

The following indications and definitions are given in connection with the preceding description of the present invention:
Polycrystalline material is understood to mean a material having several crystalline orientations or different crystalline orientation crystals.
In the sintered ceramic material, the grains together represent the essential part of the mass of said material, the intergranular phase optionally consisting of a ceramic and/or metal phase or residual carbon advantageously representing less than 5% of the mass of said material. Unlike so-called liquid-phase sintering, the process of firing the material according to the invention is essentially carried out in solid phase, that is to say that it is a sintering wherein the additives added allowing the sintering or the level of the impurities optionally present do not make it possible to form a liquid phase in an amount such that it is sufficient to allow the rearrangement of the grains and thus bring them into contact with one another. A material obtained by solid phase sintering is commonly called “solid phase sintered”.
Sintering additive, often just called an “additive” is understood to mean within the present description a compound that is customary known for enabling and/or accelerating the kinetics of the sintering reaction.
Silicon carbide (or SiC) is understood to mean the product of the reaction between a source of silicon and a source of carbon, as mixed in stoichiometric proportions of elemental silicon Si and of elemental carbon C. The product of this reaction, at a temperature of less than 1600° C. and in a non-oxidizing atmosphere, is essentially silicon carbide in the beta crystallographic form.

A powder of particles of silicon carbide essentially in beta crystalline form is understood to mean a powder for which the 3C or cubic crystallographic form represents more than 90% and preferably more than 95% by mass of silicon carbide. The alpha crystallographic forms of the silicon carbine are mainly hexagonal or rhombohedral phases: 3H; 4H; 6H and 15R.

The term “except for the free carbon” is understood to mean all the constituents of the material other than the free carbon.

Impurities are understood to mean the inevitable constituents, unintentionally and necessarily introduced with the raw materials or resulting from the reactions between the constituents. The impurities are not necessary constituents but only the tolerated constituents.

The elemental chemical contents of the sintered material or of the powders used in the mixture of the method for manufacturing said material are measured according to techniques well known in the art. In particular, the levels of elements such as, for example, Al, B, Ti, Zr, Fe, Hf, Mo, rare earth metals, alkali metals and alkaline earth metals can be measured by X-ray fluorescence, preferably by ICP (“Induction Coupled Plasma”), depending on the levels present in particular by ICP if the levels are less than 0.5%, or even less than 0.2%, in particular according to the ISO 21068-3:2008 standard for a calcinated product at 750° ° C. in air until the weight is taken up. Free silicon content, free silica, free carbon and SiC by mass are measured according to standard ISO 21068-2:2008. These oxygen and nitrogen are determined in particular by LECO according to ISO 21068-3:2008.

The polytype composition of SiC and the presence of other phases of the sintered material or of the powders used in the mixture of the method for manufacturing said material are normally obtained by X-ray diffraction and Rietveld analysis. In particular, the respective percentages of alpha and beta SiC phase can be determined using the D8 Endeavor equipment made by BRUKER using the following configuration:
Acquisition: d5f80: from 5° to 80° in 2θ, 0.01° step, 0.34 s/step, duration 46 min
Front optic: Primary slit 0.3°; Soller slit 2.5°
Sample-holder: Rotation 5 rpm/min automatic cutter
Rear optic: Soller slit: 2.5°; nickel filter 0.0125 mm; PSD: 4°. 1D detector (Current values).

The diffractograms can be analyzed qualitatively with the software EVA and the ICDD2016 database, and then they were analyzed quantitatively with the HighScore Plus software according to a Rietveld refinement.

The percentages by volume of grains of the sintered material in alpha or beta form and their diameter can be determined by analysis of images resulting from observations by electron backscatter diffraction EBSD. The installation may for example be composed of a scanning electron microscope (SEM) equipped with an EBSD detector and spectrometry with energy-dispersive X-ray spectroscopy (EDX). EBSD and EDX detectors are controlled by the software ESPRIT (version 2.1). Images of high crystallographic contrast and/or high density contrast can be collected using available software.

The equivalent diameter of a grain corresponds to the diameter of the disc of the same surface area as that of said grain observed along a cutting plane of the material. Using different sections of material according to at least two perpendicular planes it is possible to have a very good representation of the volume distribution of the different equivalent diameters of the grains and to deduce therefrom the median equivalent diameter (or D50 percentile) of said grains by volume. In the present application, the volume percentage of the sintered grains constituting the material is expressed relative to the volume of material except for its porosity.

This median equivalent diameter of grains corresponds to the diameter dividing the grains into first and second equal populations, these first and second populations comprising only grains having an equivalent diameter greater than, or less than, respectively, the median diameter.

In the same was as described above, it is also possible to calculate the volume of the intergranular phases optionally present.

The total porosity (or total volume of pores) of the material according to the invention corresponds to the total sum of the volume of closed and open pores divided by the volume of material. It is calculated according to the ratio expressed as a percentage of the bulk density measured according to ISO 18754 to the absolute density measured according to ISO 5018.

The median diameter of the particles (or the median “size”) of the particles constituting a powder can be given by a characterization of particle size distribution, in particular by means of a laser particle size analyzer. The characterization of particle size distribution is conventionally carried out with a laser particle size analyzer in accordance with the ISO 13320-1 standard. The laser particle size analyzer can be, for example, a Partica LA-950 from HORIBA. For the purposes of the present description and unless otherwise mentioned, the median diameter of the particles respectively denotes the diameter of the particles below which 50% by mass of the population is found.

“Median diameter” or “median size” of a set of particles, in particular of a powder, is called the D50 percentile, that is, the size dividing the particles into first and second populations equal in volume, these first and second populations comprising only particles having a size greater than, or less than, respectively, the median size.

A powder of particles of silicon carbide in beta crystalline form is understood to mean a powder for which the 3C or cubic crystallographic form represents more than 95% by mass of silicon carbide. The alpha crystallographic forms of the SiC are mainly hexagonal or rhombohedral phases; 3H; 4H; 6H and 15R.

The specific surface area is measured by the B.E.T. (Brunauer Emmet Teller) method, described for example in the Journal of American Chemical Society 60 (1938), pages 309 to 316.

Unless otherwise specified, all percentages in this description are mass percentages.

### EXEMPLARY EMBODIMENTS

A non-limiting example is given below, making it possible to produce a material according to the invention, which of course is also not limiting on methods that make it possible to obtain such a material and the method according to the present invention as well as comparative examples showing the advantages of the present invention.

In all the following examples, ceramic bodies in the form of cylinders with a diameter of 30 mm and a thickness of 10 mm were initially produced by casting a slip into a plaster mold according to different formulations reported in table 1 below from the following raw materials:
1) a powder of silicon carbide particles in essentially beta crystallographic form is present with a bimodal distribution with a first peak, the highest point of which is located at 0.3 micrometers and a second peak of height substantially twice as high as the first and whose highest point is situated at 3 micrometers, according to a non-cumulative size distribution measured by a laser particle size analyzer, by number. The median diameter of the bimodal powder is 1.5 μm. This SiC powder has the following elemental mass levels:
Sc+Y+La+Ce+Pr+Nd+Pm+Sm+Eu+Gd+Tb+Dy+Ho+Er+Tm+Yb+Lu<0.5%;
Nitrogen (N)<0.2%;
Na+K+Ca+Mg<0.2%;
Aluminum (Al)<0.1%;
Iron (Fe)<0.05%;
Titanium (Ti)<0.05%;
Molybdenum (Mo)<0.05%;

Its carbon, silica and free silicon contents are respectively less than 2.0%, 1.0%, and 0.1%. Its mass content of beta-SiC phase is greater than 95%.
2) a silicon carbide powder in essentially alpha crystallographic form.

It has a content of alpha SiC greater than 95% by mass. Its carbon, silica and free silicon contents are respectively less than 0.2%, 1.5%, and 0.1%.
3) a powder of carbon black provided by Timcal at grade C65 with a BET specific surface area of 62 m²/g.
4) a boron carbide B4C powder provided by H.C. Starck at grade HD-15 with a median diameter of 0.8 μm.
5) an aluminum nitride powder provided by Nanografi at grade with a median diameter of 0.06 μm.

Pellets thus produced are dried at 50° C. in air. The pellets of examples 1 and 2 (comparative) are sintered in a furnace without pressure at a temperature of 2150° C. for 2 h, respectively in argon and in N2. The pellets of examples 3 and 4 (according to the invention) and example 5 (comparative) are loaded into equipment for SPS sintering at 2000° C. under a load of 85 Mpa (megapascals) in a dinitrogen atmosphere.

Unlike examples 4 and 5, the B4C powder was replaced with an aluminum nitride powder and the sintering was carried out in a vacuum. Unlike example 1, in example 7 the starting powder is essentially beta and the sintering was carried out in a vacuum and under pressure under the same conditions as example 6.

The total porosity of the parts obtained after sintering is calculated by making the difference between 100 and the ratio expressed as a percentage of the bulk density measured according to ISO 18754 over the absolute density measured according to ISO 5018.

Free silica content (SiO₂) is measured by HF attack. The contents of free carbon, of oxygen and nitrogen are measured by LECO. The other elemental levels are measured by X-ray fluorescence and ICP.

The free silicon is measured by control with aqua regia, followed by titration. The percentage of SiC in beta form and the ratio of crystallographic form B/a SiC are determined by X-ray diffraction analysis according to the method described above.

The percentages by volume of grains of the sintered material in alpha or beta form and their diameter were determined by analysis of images resulting from EBSD observations.

The installation is composed of a scanning electron microscope (SEM) equipped with a Bruker e-FlashHR+ EBSD detector equipped with FSE/BSE Argus imaging system and a Bruker XFlash® 4010 EDX detector having an active surface area of 10 mm². The EBSD detector is mounted on one of the rear ports of the FEI Nova NanoSEM 230 scanning electron microscope with a field-emission gun at an angle of inclination equal to 10.6° relative to the horizontal in order to increase both the EBSD signal and the EDX signal. Under these conditions, the optimal working distance WD (that is to say, distance between the pole piece of the SEM and the analyzed zone of the sample) is about 13 mm. The EBSD and EDS detectors are controlled by the software ESPRIT (version 2.1). FSE images (with high crystallographic contrast) and/or BSE images (with a high density contrast) were collected using the Argus system by positioning the EBSD camera at a distance DD (sample detector distance) of 23 mm in order to be less sensitive to the topography of the sample. The EBSD measurements were carried out in point scanning and/or mapping mode. For this, the EBSD camera was positioned a distance DD of 17 mm in order to increase the collected signal.

The equivalent diameter of a grain corresponds to the diameter of the disc of the same surface area as that of said grain observed along a cutting plane of the material. By observing different sections of material along at least two perpendicular planes, it was possible to determine the distribution of the different equivalent diameters of the grains in the volume of the material and deduce therefrom the median equivalent diameter of said grains by volume.

The characteristics and properties obtained according to examples 1 to 7 are given in table 1 below.

TABLE 1

| | Ex- | Ex- | Ex- | Ex- | Ex- | Ex- | Ex- |
|---|---|---|---|---|---|---|---|
| | ample | ample | ample | ample | ample | ample | ample |
| | 1 | 2 | 3 | 4 | 5 | 6 | 7 |
| | (comp.) | (comp.) | (inv.) | (inv.) | (comp.) | (comp.) | (comp.) |
| Mixture formulation (in % by mass) | | | | | | | |
| Silicon carbide beta powder | | | 97.9 | 98.2 | 98.2 | 98.1 | 97.3 |
| Silicon carbide alpha powder | 97.3 | 97.9 | | | | | |
| Carbon black powder | 2.0 | 1.4 | 1.4 | 1.4 | 1.4 | 1.4 | 2.0 |
| B₄C powder | 0.7 | 0.7 | 0.7 | 0.4 | 0.1 | | 0.7 |
| Aluminum nitride powder | 0 | 0 | 0 | 0 | 0 | 0.5 | 0 |
| total mineral filler | 100 | 100 | 100 | 100 | 100 | 100 | 100 |
| % water/solvent | +30% | | | | | | |
| additions % relative to the | +0.4% | | | | | | |
| mass of mineral filler: | | | | | | | |
| dispersant | | | | | | | |
| Sintering/Atmosphere-Flow | Ar | N₂ | N₂ | N₂ | N₂ | In a vacuum | In a vacuum |
| (L/min/m³ furnace vol.)- | 2 L/min | 2 L/min | — | — | — | — | — |
| Temperature-Internal | 2150° C. | 2150° C. | 2000° C. | 2000° C. | 2000° C. | 2000° C. | 2000° C. |
| Pressure-with/without load | — | — | 900 mbar | 900 mbar | 900 mbar | 0 8 mbar | 0 8 mbar |
| (Mpa) or vacuum | without | without | 85 MPa | 85 MPa | 85 MPa | 85 MPa | 85 MPa |
| | load | load | | | | | |
| Chemical characteristics (in percentage by weight of the ceramic material) | | | | | | | |
| SiC (excluding the free C) | >99 | >99 | >99 | >99 | >99 | >99 | >99 |
| N | <0.05 | < | 0.11 | 0.10 | 0.11 | 0.22 | 0.06 |
| B | 0.55 | 0.55 | 0.55 | 0.31 | 0.08 | <0.05 | 0.55 |
| + | 0.25 | <0.25 | <0.25 | <0.25 | <0.25 | 0.10 | <0.25 |
| Na | <0.04 | <0.04 | <0.04 | <0.04 | <0.04 | <0.04 | <0.04 |
| K | <0.05 | <0.05 | <0.05 | <0.05 | <0.05 | <0.05 | <0.05 |
| Ca | <0.04 | <0.04 | <0.04 | <0.04 | <0.04 | <0.04 | <0.04 |
| Mg | <0.04 | <0.04 | <0.04 | <0.04 | <0.04 | <0.04 | <0.04 |
| Al | <0.3 | <0.3 | <0.3 | <0.3 | <0.3 | 0.4 | <0.3 |
| Cr | <0.05 | <0.05 | <0.05 | <0.05 | <0.05 | <0.05 | <0.05 |
| Mo | <0.1 | <0.1 | <0.1 | <0.1 | <0.1 | <0.1 | <0.1 |
| Sc, Y, La, Ce, Pr, Nd, | <0.01 | <0.01 | <0.01 | <0.01 | <0.01 | <0.01 | <0.01 |
| Pm, Sm, Eu, Gd, Tb, Dy, | | | | | | | |
| Ho, Er, Tm, Yb and Lu | | | | | | | |
| Fe | <0.03 | <0.03 | <0.03 | <0.03 | <0.03 | <0.03 | <0.03 |
| Ti | <0.05 | <0.05 | <0.05 | 0.05 | <0.05 | <0.05 | <0.05 |
| Hf | <0.01 | <0.01 | <0.01 | <0.01 | <0.01 | <0.01 | <0.01 |
| Zr | 0.02 | 0.02 | 0.02 | 0.02 | 0.02 | 0.02 | 0.02 |
| Free (metallic) silicon | <0.01 | <0.01 | <0.01 | <0.01 | <0.01 | <0.01 | <0.01 |
| Free silica (SiO₂) | <0.4 | <0.4 | <0.4 | <0.4 | <0.4 | <0.4 | <0.4 |
| Free carbon (C) | 1.7 | 1.1 | 1.1 | 1.1 | 1.1 | 1.1 | 1.7 |
| Crystallographic characteristics (as a % by mass of the | | | | | | | |
| crystallized phases of the ceramic material) | | | | | | | |
| βSiC (%) | N.D. | N.D. | 5 | 47 | 95 | 83 | N.M |
| Mass ratio βSiC/αSiC | #0 | #0 | <0.1 | 0.9 | > 19 | >12 | N.M |
| Total porosity (%) | 8.0 | 23.0 | 0.6 | 0.9 | 9.0 | 3.7 | 1.9 |
| Structural features relative to the volume of material apart from its porosity | | | | | | | |
| Equivalent median diameter | 7 | 7 | 35 | 3.5 | 2.1 | 2.1 | >30 |
| of sintered grains in μm | | | | | | | |
| % volume of grains with | >80 | >80 | 95 | >95 | >95 | N.M | N.M |
| equivalent diameter of | | | | | | | |
| between 1 and 10 μm | | | | | | | |
| Equivalent median diameter | 7 | 7 | 6.5 | <5 | <1 | N.M | N.M |
| of the sintered grains of | | | | | | | |
| αSiC in μm | | | | | | | |

N.D. = Not detectable
N.M = not measured

The examples according to the invention show that it is possible to obtain a highly pure, very dense crystallized silicon carbide material according to a very specific method that comprises mixing silicon carbide SiC in essentially beta form, moderately adding sintering additive, in the presence of carbon, the sintering being carried out under pressure and in a pure nitrogen atmosphere. Examples 6 and 7 (comparative) show that vacuum sintering, whether the sintering additive used provides nitrogen (example 6) or not (example 7), does not make it possible, unlike the method according to the invention, to obtain a material of SiC that is as dense, that is to say with a porosity of less than 2%, or even less than 1%, and having a median equivalent diameter of grains of between 1 and 10 micrometers.

1. A polycrystalline silicon carbide sintered material consisting of silicon carbide grains having a median equivalent diameter of between 1 and 10 microns, said material having a total porosity of less than 2% by volume of said material, and a silicon carbide (SiC) mass content of at least 99%, except for free carbon, wherein in said material a mass ratio of the content of SiC having a beta-type (β) crystallographic form to the content of SiC having an alpha-type (α) crystallographic form is less than 2, said material having a following elemental composition, by mass:
less than 0.5% silicon in another form than SiC,
less than 2.0% carbon in another form than SiC, and
between 0.1 and 0.7%, in total, of at least one element selected from Al, B, Fe, Ti, Cr, Mg, Hf, Zr,
less than 0.5% oxygen (O) and
less than 0.5% in total of the elements Sc, Y, La, Ce, Pr, Nd, Pm, Sm, Eu, Gd, Tb, Dy, Ho, Er, Tm, Yb and Lu, and
less than 0.5% alkali elements, and
less than 0.5% alkaline earth, and
between 0.05 and 1% nitrogen (N),
the other elements forming the complement to 100%.

2. The material according to claim 1, wherein said material comprises more than 1% SiC in beta crystallographic form relative to the total mass of the crystalline phases in the material.

3. The material according to claim 1, wherein by volume of said material apart from its porosity, more than 90% of the grains have an equivalent diameter of between 1 and 10 microns.

4. The material according to claim 1, wherein by mass of said material:
the elemental mass content of nitrogen (N) is between 0.05 and 0.5%.

5. The material according to claim 1, wherein in which the mass content of boron (B) is greater than 0.1% and less than 0.7% by weight of said material.

6. The material according to claim 1, wherein the mass ratio of the SiC content in beta crystallographic form (β) to the SiC content in alpha crystallographic form (α) SiC in said material is less than 1.

7. The material according to claim 1, wherein the silicon carbide grains represent at least 98%, by mass of said material, the remainder consisting of a residual intergranular phase comprising elements Si and C.

8. The material according to claim 1, wherein more than 90% by volume of the silicon carbide grains in alpha crystalline form have an equivalent diameter of less than 10 micrometers.

9. A method for manufacturing a polycrystalline silicon carbide sintered material according to claim 1, comprising:
a) preparing a mineral feedstock comprising by mass:
at least 95%, silicon carbide particles, in the form of a powder, a median size of which is between 0.1 and 5 micrometers and with a SiC mass content greater than 95%, wherein the beta crystallographic form represents more than 90%, of the total mass of the silicon carbide, and
at least one solid-phase sintering additive comprising an element selected from aluminum, boron, iron, titanium, chromium, magnesium, hafnium or zirconium in an amount such that the contribution of said element represents between 0.1 and 0.8% of the total mass of said particles of silicon carbide,
between 0.5 and 3% of a carbon source whose elemental carbon content (C) is greater than 99% by mass, a median diameter of which is less than 1 micrometer,
b) shaping the feedstock into the form of a preform,
c) solid phase sintering of said preform under a pressure greater than 60 MPa and at a temperature greater than 1800° C. and less than 2100° C. in a nitrogen atmosphere.

10. The method according to claim 9, wherein the mass content of free carbon in the powder of silicon carbide particles is less than 2%.

11. The method according to claim 9, wherein the mass content of free silica in the powder of silicon carbide particles is less than 1%.

12. The method according to claim 9, wherein the mass content of free silicon in the powder of silicon carbide particles is less than 0.5%.

13. The method according to claim 9, wherein the mass content of said powder of silicon carbide particles in the sum of the elemental contents of aluminum (Al), alkali, alkaline earth, and rare earth metals, comprising at least one element selected from Sc, Y, La, Ce, Pr, Nd, Pm, Sm, Eu, Gd, Tb, Dy, Ho, Er, Tm, Yb and Lu, is less than 0.5%.

14. The method according to claim 9, wherein the element comprised in the sintering additive is boron.

15. The method according to claim 9, wherein the step of solid phase sintering of said preform is carried out by Spark Plasma Sintering.

16. A device comprising the material according to claim 1, said device being chosen from: a turbine, a pump, a valve or a fluid line system, a heat exchanger; a solar absorber or a device for recovering heat or reflecting light, a furnace refractory coating, a cooking surface, a crucible for melting metal, an abrasion protection part, a cutting tool, a brake pad or disc, a radome, a coating or support for thermochemical treatment, or a substrate for active layer deposition for the optics and/or electronics industry; a heating element or resistor; a temperature or pressure sensor; an igniter; a magnetic susceptor.

17. The material according to claim 1, wherein said material comprises less than 1.5% carbon in another form than SiC.

18. The material according to claim 1, wherein said material comprises between 0.1 and 0.7%, in total, of at least one element selected from Zr, Ti, Hf, B.

19. The material according to claim 7, wherein the silicon carbide grains represent at least 99% by mass of said material.

20. The material according to claim 7, wherein the residual intergranular phase consists essentially of elements Si and C.
